(19) United States
(12) Patent Application Publication
(10) Pub. No.: US 2005/0084588 A1
(43) Pub. Date: Apr. 21, 2005

(54) Snack foods comprising emulsified liquid shortening compositions comprising dietary fiber gel, water and lipid

(76) Inventors: Triveni P. Shukla, New Berlin, WI (US); Gregory J. Halpern, Vernon Hills, IL (US)

Correspondence Address: Timothy J. Fullin;Fullin Legal Services LLC, 711 North Milwaukee Avenue, Libertyville, IL, 60048, US

(21) Appl. No.: 10/689,208

(22) Filed: Oct. 20, 2003

(51) Int. Cl. A23L 1/05

(52) U.S. Cl. 426/573

(57) ABSTRACT

According to the present invention, fat and caloric content of snack foods can be reduced by the replacement of a portion fat content normally found in snack foods with an equal amount of emulsified liquid shortening composition comprising dietary fiber gel, water and lipid. The result is that fat and caloric content of snack foods can be manipulated with minimal effect on taste and texture. Furthermore, these emulsified mixtures, or “emulsified liquid shortening compositions comprising dietary fiber gel, water and lipid”, can further comprise functional foods such as high omega three and omega six oils and pure omega three and omega six fatty acids, medium chain triglyceride, beta carotene, calcium estearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof Hence, in addition to reducing fat and caloric content of snack foods, further health benefits can be achieved by replacing a portion of fat with emulsified liquid shortening compositions comprising dietary fiber gel, water and lipid.

### CROSS-REFERENCE TO RELATED APPLICATIONS

Not Applicable

### STATEMENT REGARDING FEDERALLY SPONSORED RESEARCH/DEVELOPMENT

The present invention does not involve any form of federally sponsored research or development.

### BACKGROUND OF THE INVENTION

The present invention relates to snack foods comprising emulsified liquid shortening compositions comprising dietary fiber gel, water and lipid. Recent media attention to the global problem of obesity demonstrates a need for greater availability of foods with low caloric and fat content. This is especially true for foods that typically have high fat and caloric content, such as snack foods.

Snack foods typically comprise some fat. Other ingredients can vary according to the type of snack food and the recipe followed, but typically, snack foods are high in both fat and caloric content. Snack foods can be divided into two broad classes: salty snack foods, such as chips and crackers, and sweet snack foods, such as candies and snack bars, for example granola bars and nutrition bars.

In recent years, some companies have begun to offer reduced fat snack foods. This variety of snack food, however, often fails to retain the desirable taste and texture of snack foods comprising higher fat contents.

The absence of a means to reduce the fat and caloric content of snack foods while still producing a desirably flavored and textured snack food presents an unmet need in today's food industry.

### E. BRIEF SUMMARY OF THE INVENTION

It is an object of the present invention to provide a unique composition of matter embodied by low-calorie and low-fat snack foods. This reduction in caloric and fat content answers an unmet need in the food industry to provide the consuming public with a healthier, higher fiber alternative to traditional types of snack foods that typically are inherently fattening. It is another object of the present invention to provide snack foods that have been fortified with insoluble fiber and other functional foods.

Dietary fiber gels for calorie reduced foods hold the key to meeting this need. Dietary fiber gels for calorie reduced foods are fully described in U.S. Pat. No. 5,766,662 (the '662 patent). These dietary fiber gels comprise insoluble dietary fibers consisting of morphologically disintegrated cellular structures, and are characterized by their ability to retain large amounts of water. Additionally, these dietary fiber gels are characterized by their high viscosity at low solid levels. Other insoluble fibers derived from cereals, grains and legumes consist of morphologically in tact cellular structures, and thus impart a gritty texture to the foods in which they are contained. The dietary fiber gels disclosed in the '662 patent, however, consist of morphologically disintegrated cellular structures and thus impart a smoother texture than other insoluble fiber formulations.

More specifically, the present invention utilizes emulsified mixtures of the dietary fiber gels disclosed in the '662 patent, the emulsified mixtures further comprising, at a minimum, water and lipid. These emulsified mixtures are fully described in and are the subject of U.S. patent application Ser. No. 10/669731 filed Sep. 24, 2003. These emulsified mixtures, or “emulsified liquid shortening compositions comprising dietary fiber gel, water and lipid”, can further comprise functional foods such as high omega three and omega six oils and pure omega three and omega six fatty acids, medium chain triglyceride, beta carotene, calcium estearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof. Hence, in addition to reducing fat and caloric content of snack foods, further health benefits can be achieved by replacing a portion of fat with emulsified liquid shortening compositions comprising dietary fiber gel, water and lipid.

According to the present invention, fat and caloric content can be reduced by the replacement of the fat normally found in snack foods with emulsified liquid shortening compositions comprising dietary fiber gel, water and lipid. This replacement of fat does not adversely affect either the taste or texture of the snack foods. The result is that fat and caloric content of snack foods can be manipulated with minimal effect on taste and texture, and as stated above, additional health benefits can be achieved through consumption of snack foods comprising emulsified liquid shortening compositions comprising dietary fiber gel, water and lipid when functional foods are included in the formulations.

Further objects, advantages and features of the present invention will present themselves in the following detailed description.

### DETAILED DESCRIPTION OF THE PREFERRED EMBODIMENT

This invention is directed to snack foods comprising emulsified liquid shortening compositions comprising dietary fiber gel, water and lipid. According to the present invention, fat and caloric content can be reduced by the replacement of the fat normally found in snack foods with emulsified liquid shortening compositions comprising dietary fiber gel, water and lipid (hereinafter “emulsified liquid shortening”). This replacement of fat does not adversely affect either the taste or texture of the snack foods. The result is that fat and caloric content of snack foods can be manipulated with minimal effect on taste and texture.

Salty snack foods, for example crackers and chips, can be formulated such that the snack food comprises 0.1 percent to 5.0 percent dietary fiber gel solids by replacing an appropriate amount, that is, an amount prorated to deliver this range of dietary fiber gel solids, of fat, including oil and liquid shortening, with an essentially identical amount of emulsified liquid shortening. Sweet snack foods, for example candies and nutrition bars, can be formulated such that the snack food comprises 0.1 percent to 5.0 percent dietary fiber gel solids by replacing an appropriate amount, that is, an amount prorated to deliver this range of dietary fiber gel solids, of fat, including oil and liquid shortening, with an essentially identical amount of emulsified liquid shortening.

The result is that fat and caloric content of snack foods can be manipulated with minimal effect on taste and texture, and as stated above, additional health benefits can be achieved through consumption of snack foods comprising emulsified liquid shortening compositions comprising dietary fiber gel, water and lipid when functional foods are included in the formulations.

1. snack food, the snack food having a formulation, the snack food comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.1 percent to 5.0 percent by weight of the overall snack food formulation, and
the emulsified liquid shortening composition comprising dietary fiber gel, water and lipid replaces an equal amount of fat used in an otherwise identical recipe of snack food that uses no emulsified liquid shortening compositions comprising dietary fiber gel, water and lipid.

2. chips, the chips having a formulation, the chips comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.1 percent to 5.0 percent by weight of the overall chips formulation, and
the emulsified liquid shortening composition comprising dietary fiber gel, water and lipid replaces an equal amount of fat used in an otherwise identical recipe of chips that uses no emulsified liquid shortening compositions comprising dietary fiber gel, water and lipid.

3. crackers, the crackers having a formulation, the crackers comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.1 percent to 5.0 percent by weight of the overall crackers formulation, and
the emulsified liquid shortening composition comprising dietary fiber gel, water and lipid replaces an equal amount of fat used in an otherwise identical recipe of crackers that uses no emulsified liquid shortening compositions comprising dietary fiber gel, water and lipid.

4. candy, the candy having a formulation, the candy comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.1 percent to 5.0 percent by weight of the overall candy formulation, and
the emulsified liquid shortening composition comprising dietary fiber gel, water and lipid replaces an equal amount of fat used in an otherwise identical recipe of candy that uses no emulsified liquid shortening compositions comprising dietary fiber gel, water and lipid.

5. snack bars, the snack bars having a formulation, the snack bars comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.1 percent to 5.0 percent by weight of the overall snack bars formulation, and
the emulsified liquid shortening composition comprising dietary fiber gel, water and lipid replaces an equal amount of fat used in an otherwise identical recipe of snack bars that uses no emulsified liquid shortening compositions comprising dietary fiber gel, water and lipid.

6. granola bars, the snack bars having a formulation, the granola bars comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.1 percent to 5.0 percent by weight of the overall granola bars formulation, and
the emulsified liquid shortening composition comprising dietary fiber gel, water and lipid replaces an equal amount of fat used in an otherwise identical recipe of granola bars that uses no emulsified liquid shortening compositions comprising dietary fiber gel, water and lipid.
